(19) United States
(12) Patent Application Publication
(10) Pub. No.: US 2009/0287580 A1
(43) Pub. Date: Nov. 19, 2009

(54) METHOD AND SYSTEM FOR DISTRIBUTING, SELLING, AND REDEEMING LOTTERY TICKETS

(75) Inventor: KENNETH E. IRWIN, JR., DAWSONVILLE, GA (US)

Correspondence Address: DORITY & MANNING, P.A., POST OFFICE BOX 1449, GREENVILLE, SC, 29602-1449, US

(73) Assignee: SCIENTIFIC GAMES INTERNATIONAL, INC., NEWARK, DE (US)

(21) Appl. No.: 12/467,323

(22) Filed: May 18, 2009

Related U.S. Application Data
(60) Provisional application No. 61/054,269, filed on May 19, 2008.

(51) Int. Cl. G06Q 50/00; G06Q 10/00; G06Q 30/00; G06F 17/00

(52) U.S. Cl. 705/21; 705/400; 700/241

(57) ABSTRACT

A method for distribution and sale of lottery tickets includes defining sets of lottery tickets uniquely designated for a particular retail establishment, with the number and prize amount of winning tickets within each set being known to the central lottery authority. The sets of lottery tickets are provided to the respective designated retail establishments at a price that is a function of the total sales value of all of the tickets within the set to the purchasing public. The lottery tickets are sold to patrons of the retail establishment, while making known to the patrons that winning lottery tickets are redeemable only at the retail establishment where the lottery tickets were sold. Any winning tickets are redeemable only at the retail establishment at which the winning lottery tickets were sold. Lottery tickets uniquely configured for use in the system are also encompassed.

### PRIORITY CLAIM

The present application claims priority to U.S. Provisional Application Ser. No. 61/054,269, filed May 19, 2008.

### FIELD OF THE INVENTION

The present invention relates to the field of lottery games in general, and more particularly to a method and system for distributing, selling, and redeeming lottery tickets.

### BACKGROUND

Instant win lottery tickets (e.g., scratch-off and pull-tab tickets) have been a staple of the lottery industry for many years. The industry is, however, continuously seeking ways to generate increased interest and excitement in the gaming experience, and to draw in new players. One potential new arena for lottery games that has been generally reticent to the distribution and sale of lottery tickets is the “social establishment” business sector that includes, for example, bars, taverns, restaurants, clubs, and the like. These establishments generally avoid carrying lottery game tickets because of the logistics of handling the product, for example the costs associated with carrying an inventory of unsold products.

The conventional lottery ticket distribution scheme works on a consignment basis wherein the central lottery authority provides packs or bundles of tickets to retailers. An inventory of tickets is maintained by the retailers as “manifested” products. The tickets are eventually “activated” for sale by the retailer, and at some triggering event, the retailer “settles” with the lottery authority for the purchase of the tickets. The settling event may be, for example, some designated time period after activation, or when a designated percentage of winning tickets from an activated pack have been redeemed, or when the next pack of tickets is activated, or when the designated pack of tickets is delivered, and so forth. The retailer is typically liable to the lottery authority for the sales value of the activated tickets, minus an agreed upon sales commission, typically in the range of about 5%-7%. Although quite efficient for certain types of retail establishments, this system does require employee time for maintaining a supply of manifested tickets, and accounting for purchase of activated tickets. Social establishment businesses generally do not have employees for this purpose.

Attempts have been made in the past to reduce the logistical burden discussed above by, for example, providing instant lottery tickets directly to the purchasing public via vending machines. In fact, automated instant lottery ticket vending machines have expanded into traditional lottery venues, such as grocery stores, convenience stores, and the like. However, for the most part, such machines have not been readily accepted in social establishments such as restaurants and taverns due primarily to cost and security issues and the fact that inventory for the machines still must be maintained by the establishment.

The present invention relates to a system and methodology for distributing and selling lottery tickets that addresses certain of the problems discussed above and, thus, may make lottery games more attractive to social establishment retail locations.

### SUMMARY

Objects and advantages of the invention will be set forth in part in the following description, or may be obvious from the description, or may be learned through practice of the invention.

In accordance with certain embodiments, a method for the distribution and sale of lottery tickets is provided. The method is not limited to any particular type or configuration of lottery tickets, and has particular utility with any conventional type of instant lottery ticket. Examples of instant lottery tickets include scratch-off and pull-tab lottery tickets having various themes. The lottery tickets are defined as sets, wherein each set is designated for a particular retail establishment. The sets may be provided as a pack, bundle, brick, or any other convenient or conventional package of tickets. The number and prize amount of winning tickets within each set are known by the lottery authority when the ticket sets are distributed. It should also be appreciated that the present method is not limited to distribution to any particular type of retail establishment, and may include any establishment wherein it is desired to provide lottery tickets to the public. The method is uniquely suited for distribution to social retail establishments, such as bars, pubs, taverns, restaurants, cafes, and the like, frequented by patrons, that have generally not been recognized as likely venues for lottery games.

The lottery ticket sets are provided to the respective designated retail establishments at a price that is a function of the a priori value of all of the tickets within the set. For example, the set may contain 100 tickets that are sold to the public for $1.00 per ticket, whereby the set has a total sales value of $100.00. Of this amount, a given percentage is designated to cover the prize awards for tickets within the set, for example a 65% payout for the lottery game implies that $65.00 of the total sales value is designated for prize awards. The remaining 35% is returned to the lottery authority. The price to the retail establishment may thus be $35.00 less an agreed upon sales commission, for example a commission of 5%-7%. The retail establishment may be invoiced at the time of delivery or acceptance of the tickets, or at some other agreed upon time or event.

The retail establishment sells the lottery tickets to its patrons, and the patrons are made aware that any winning lottery ticket sold by the retail establishment can only be redeemed at the retail establishment. This notice may be provided on any of the materials advertising the lottery, at materials provided at the point of sale of the tickets in the retail establishment, or by any other convenient means. It may be desirable to also provide such notice directly on the lottery tickets.

Accordingly, any winning lottery tickets are presented by the patrons to the retail establishment for their prize value, and the retail establishment only redeems winning tickets sold at the respective establishment.

The method may further include providing any manner of indicia on the lottery tickets that indicates the retail establishment at which the lottery tickets are sold and redeemed. This indicia may be, for example, any manner of advertising material.

The lottery ticket sets may be provided to the retail establishments by a central lottery authority or directly from the lottery ticket manufacturer via any suitable distribution system.

Inevitably, a certain percentage of winning lottery tickets in a pack or bundle are not redeemed by purchasers for any number of reasons. As an incentive to further promote the lottery game, the retail establishments may be allowed to keep any unclaimed prize awards. For example, in the scenario discussed above, the retail establishment would be allowed to keep any unclaimed portion of the $65.00 designated for prize awards.

The present invention also encompasses lottery tickets configured for use in the system and methodology discussed above, wherein lottery tickets incorporating any manner of lottery game in a designated game play area are provided to patrons of a retail establishment, particularly a social establishment. The tickets include any manner of indicia that visually indicates to purchasers the retail establishment where they are purchasing the ticket, with the indicia being unique to a particular retail establishment such that the lottery tickets are associated with only a single retail establishment. Indicia may also be provided on the tickets to notify purchasers that any winning lottery ticket must be redeemed at the retail establishment indicated on the lottery ticket. In this manner, the lottery tickets are thereby sold and redeemed only at the retail establishment indicated on the lottery tickets.

Aspects of the invention are described in greater detail below by reference to the embodiments illustrated in the figures.

### BRIEF DESCRIPTION OF THE DRAWINGS

FIG. 1 is a perspective view of a front side of an exemplary lottery ticket that may be used in a system and methodology of the present invention;

FIG. 2 is a perspective view of a front side of another exemplary lottery ticket that may be used with the system and method of the present invention;

FIG. 3 is a diagram and graphical view illustrating feature of an exemplary method in accordance with aspects of the invention; and

FIG. 4 is a perspective view of a back side of an exemplary lottery ticket that may be used with the system and method of the present invention.

### DETAILED DESCRIPTION

Reference will now be made to embodiments of the invention, examples of which are illustrated in the drawings. Each embodiment is provided by way of explanation of the invention, and not as a limitation of the invention. For example, features illustrated or described as part of one embodiment may be used with another embodiment to yield still a further embodiment. It is intended that these and other modifications and variations to the embodiments described herein be within the scope and spirit of the present invention.

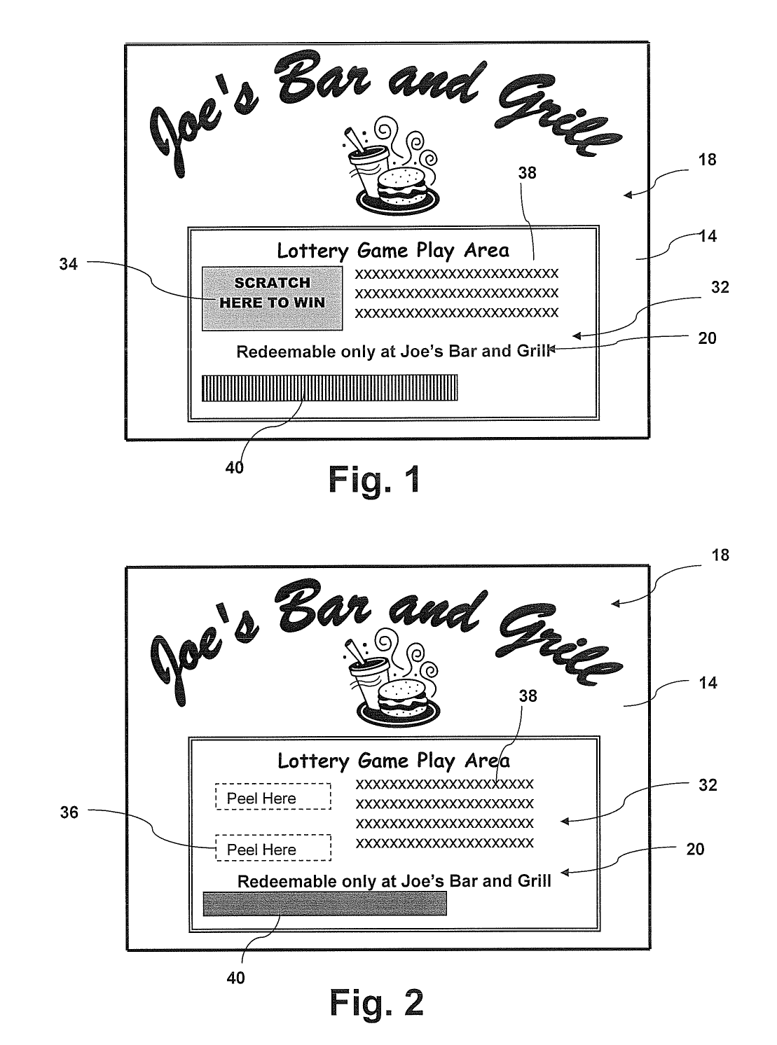

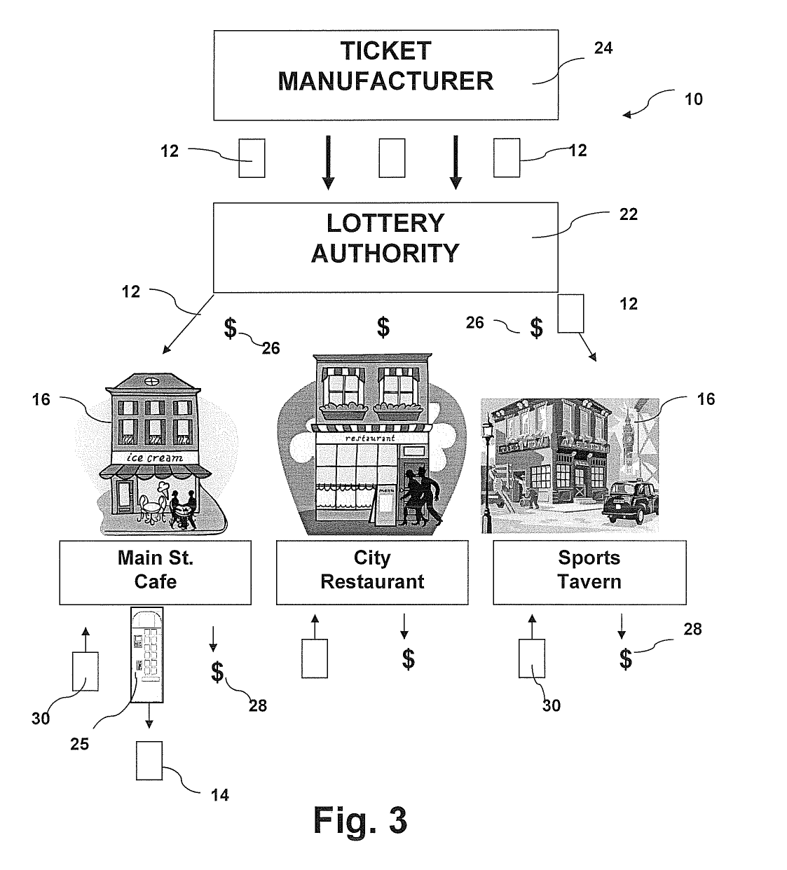

FIG. 3 graphically illustrates concepts of a method 10 for distribution and sale of lottery tickets 14 (FIGS. 1 and 2) implementing any desired type of lottery game to retail establishments 16. As mentioned above, the method 10 is not limited to any particular type or configuration of lottery tickets 14, and has particular utility with conventional styles of instant lottery tickets, as discussed below with reference to FIGS. 1 and 2. The lottery tickets are defined as sets 12 that may take on any physical embodiment, such as a pack, package, book, brick, and the like, having a known number of tickets 14. Each set 12 is uniquely designated for a particular retail establishment 16.

The sets 12 may be provided to the retail establishments 16 from a central lottery authority 22, who receives the sets 12 from a ticket manufacturer 24. In other embodiments, the sets 12 can be delivered directly to the retail establishments 16 from the manufacturer 24 per instructions from the lottery authority 22. The ticket sets 12 are made by the manufacturer 24 so as to be uniquely identifiable with a particular retail establishment 16.

Each of the ticket sets 12 contains a predetermined number of winning tickets 14 having a given prize value, with such information being provided to the lottery authority 22 by the ticket manufacturer 24. Thus, the number and prize amount of winning tickets 14 within each set are known by the lottery authority 22 when the ticket sets 12 are distributed to the retail establishments 16.

As mentioned, it should also be appreciated that the present method is not limited to distribution to any particular type of retail establishment 16, and may include any establishment wherein it is desired to provide lottery tickets to the public. As described herein, the method is uniquely suited for distribution to social retail establishments, such as bars, pubs, taverns, restaurants, cafes, and the like, frequented by patrons, but is not limited to such places.

Still referring to FIG. 3, the lottery ticket sets 12 are provided to the respective designated retail establishments 16 at a price 26 that is a function of the total sales value of all of the tickets within the set, as described with the example set forth above. In general, the price 26 to the retail establishment 16 will generally be the percentage of the sales value designated for the lottery authority minus a sales commission. The percentage of the sales value designated for prize awards is retained by the retail establishments for payout upon subsequent redemption of winning tickets 14 from patrons of the establishment. The retail establishment may be invoiced at the time of delivery or acceptance of the ticket sets 12, or at some other agreed upon time or event.

The retail establishments 16 sell the lottery tickets 14 to their patrons, and the patrons are made aware that any winning lottery ticket 14 sold by the retail establishment can only be redeemed at the retail establishment. This notice may be provided on any of the materials advertising the lottery, at materials provided at the point of sale of the tickets in the retail establishment, or by any other convenient means. In a desirable embodiment, this redemption notice is provided directly on the lottery tickets 14, as indicated by the notice indicia 20 on the tickets 14 of FIGS. 1 and 2. Accordingly, any winning tickets 30 (FIG. 3) are redeemed at the establishment 16 where the ticket was sold for a prize award 28 paid directly by the retail establishment 16. As discussed, the prize award for any winning lottery tickets 30 that are not redeemed by a purchaser may be retained by the retail establishment 16 as an incentive 28.

FIGS. 1 and 2 illustrate concepts of exemplary lottery tickets 14 that may be used in the methodology discussed above. Each ticket 14 may include any manner of indicia 18 that indicates or identifies the retail establishment 16 at which the lottery tickets are sold and redeemed. This indicia 18 may be, for example, any manner of advertising material that uniquely identifies or promotes the establishment 16 se-ling the tickets 14. The ticket 14 may actually be a component of a larger item, such as a menu or other item distributed by the establishment 16 to its patrons. Thus, it should be understood that “ticket” is used herein to refer to any article or medium that incorporates a lottery game play area 32 by which purchasers play a designated lottery game.

It should be appreciated that the particular type of lottery game is not a limiting feature. For example, the game play area 32 may incorporate any manner of instant scratch-off lottery game wherein a purchaser determines if the ticket is a winner by removing an opaque layer from scratch-off layer 34 to reveal underlying game indicia. The lottery game play area 32 may include any other features commonly found on lottery tickets, such as indicia 38 advertising or describing the game, rules of the game, prize payouts, and so forth. A bar code 40 or other feature may be provided for any number of reasons, including security, validation, inventory, or any other desired option related to administration of the lottery game.

FIG. 2 illustrates a ticket similar to FIG. 1 wherein the lottery game component of the play area 32 incorporates any manner of conventional peel-tab (a.k.a. Pull-Tab) game wherein a purchaser determines if the ticket is a winner by peeling away tabs 36 to reveal underlying game indicia.

Thus, the presence (branding) of the establishment's name and logo ties the ticket to the selling establishment. The branding of the ticket allows the establishment to pay prizes only for tickets sold at that location. This makes ticket redemption more personal with the consumer receiving prizes only from the same establishment that sold the ticket. Historically, this type of personal interaction reduces fraud and builds up long-term relationships. More importantly, only redeeming tickets at the establishment where they were sold, allows the lottery to discount the purchase price of a pack of tickets by the total of all prizes contained in that pack.

Thus, the branding of tickets with the selling establishment's name and logo may be a highly desirable feature for social establishments, helping the retailer with security as well as reduced inventory carrying costs. However, the logistics of preprinting a limited number of tickets for each social establishment at the time of manufacture may be expensive and cumbersome.

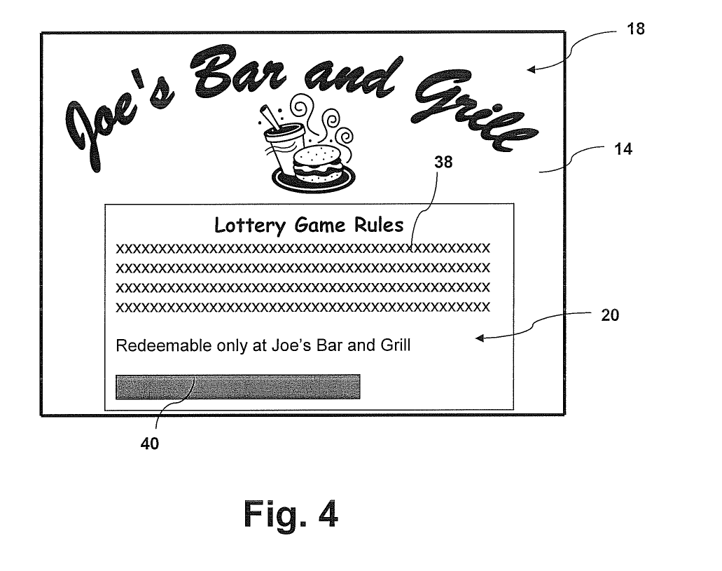

Part of the logistical manufacturing problem can be addressed by inkjet imaging the back of the tickets when printed. Lottery ticket printers typically have ink jet imaging equipment available inline for printing barcodes on instant tickets. By ink jet imaging the social establishment's name and logo at the same time the instant tickets are printed, the tickets can be produced and packaged ready for the designated store/establishment. FIG. 4 illustrates the back side of an exemplary ticket 14 wherein the indicia 18 and notice 20 related to the retail establishment is prominently displayed. This may be in addition to indicia on the front side of the ticket 14, as in FIGS. 1 and 2.

With the use of ink jet imaging (or other variable imaging technology) the cumbersome and time-consuming task of swapping out printing plates or cylinders (e.g., Flexographic, offset, gravure, etc.) is eliminated, allowing the printing press to run continuously printing all of the tickets for all establishments in a lottery's domain at one time. Therefore the cost of semi-customized ticket production is greatly reduced.

In different embodiments, the instant lottery tickets may be branded when received at the establishment that will sell the tickets. This secondary ticket customization process can be accomplished with a one-dimensional print head to brand the tickets as they were advanced that would allow for both monochromatic and color printing including: ink ribbon, ink jet, xerography, phaser, etc.

Another embodiment of the brand-when-received concept is a customization device that punches a series of identifier holes in a non-critical area of the instant ticket. These holes could be small and printed in a matrix fashion that would allow the unit to spell out the name of the establishment, or provide any other manner of identifying the establishment. This type of branding has the advantage of not requiring consumables, like ink jet dye.

Yet another embodiment of the brand-when-received concept is to customize an instant ticket with the use of thermal printing on a predetermined area. In this embodiment, the ticket would be preprinted with thermally sensitive ink that remained transparent unless a high degree of heat was applied. Once the heat was applied, the heat sensitive ink would shift from transparent to black or some other predetermined color. Obviously, to be of utility for branding, the heat sensitive ink would be of a phase shifting nature, i.e., once the ink was transformed it would not shift back to its previous transparent state even when cooled to room temperature.

In yet another embodiment of the brand-when-received concept the customization of an instant ticket is achieved with the application of a sticker to the ticket. In this embodiment, the ticket would have white space where the branding sticker will be applied. The branding stickers could be delivered in rolls that permit automatic application of the stickers to the back of the tickets by a machine.

All of the above embodiments for a brand-when-received at the establishment could be implemented in a vending machine, as conceptually illustrated by the vending machine 25 in FIG. 3. In this embodiment, the tickets would use the same processes discussed above, but would be branded only when dispensed. This embodiment may be desirable, since the tickets are only branded when dispensed and unsold tickets could be returned to the lottery for sale at other establishments.

It should be appreciated by those skilled in the art that modifications and variations can be made to the embodiments of the invention described herein without departing from the scope of the appended claims or their equivalents.

What is claimed is:

1. A method for distribution and sale of lottery tickets, said method comprising:
defining sets of lottery tickets, wherein each set is designated for a particular retail establishment and the number and prize amount of winning tickets within each set are known;
providing the sets of lottery tickets to the respective designated retail establishments at a price that is a function of the total sales value of all of the tickets within the set to the public;
selling the lottery tickets to patrons of the retail establishment via automatic vending, and making known to the patrons that winning lottery tickets are redeemable only at the retail establishment where the lottery tickets were sold; and
redeeming the winning lottery tickets only at the retail establishment at which the winning lottery tickets were sold.

2. The method as in claim 1, further comprising providing indicia on the lottery tickets that identifies the retail establishment at which the lottery tickets are sold and redeemed.

3. The method as in claim 2, comprising providing notice on the lottery tickets that such tickets are only redeemable at the retail establishment indicated on the lottery ticket.

4. The method as in claim 1, wherein the purchase price of the lottery ticket packs to the retail establishment corresponds to a percentage of the total sales value of the packs minus an established sales commission between a central lottery authority and the retail establishments.

5. The method as in claim 1, further comprising allowing the retail establishments to keep the prize amount of any winning tickets from a lottery ticket set that are not redeemed.

6. The lottery tickets as in claim 1, wherein said game play area comprises an instant scratch-off lottery game.

7. The lottery tickets as in claim 1, wherein said game play area comprises a pull-tab lottery game.

8. The method of claim 3, wherein the indicia and notice on the lottery tickets that such tickets are only redeemable at the retail establishment is automatically printed at the time the ticket is dispensed by a vending machine at the retail establishment.

9. The method of claim 8, wherein the vending machine prints the indicia and notice on the lottery tickets by one of a ink jet, flexographic, xerography, or phaser color printing process.

10. The method of claim 3, wherein the indicia and notice on the lottery tickets is provided on a sticker that is applied by the vending machine.

11. Lottery tickets configured for sale to the public at a retail establishment, said lottery tickets comprising:
a game play area;
indicia that visually indicates to purchasers the retail establishment where they are purchasing said ticket, said indicia being unique to a particular retail establishment such that said lottery tickets are associated with only a single retail establishment;
indicia that serves to notify purchasers that any winning lottery ticket must be redeemed at the retail establishment indicated on said lottery ticket;
whereby said lottery tickets are thereby sold and redeemed only at the retail establishment indicated on said lottery tickets.

12. The lottery tickets as in claim 11, wherein said game play area comprises an instant scratch-off lottery game.

13. The lottery tickets as in claim 11, wherein said game play area comprises a pull-tab lottery game.

14. The lottery tickets as in claim 11, wherein said tickets are arranged in sets, with each said set designated for a different retail establishment and said lottery tickets within each said set comprising said indicia that is unique to the respective retail establishment.

15. The lottery tickets as in claim 11, wherein said indicia is provided by a sticker applied on said lottery tickets.

16. The lottery tickets as in claim 11, wherein said indicia is provided by punched holes in said lottery ticket.
